(19) United States
(12) Patent Application Publication
(10) Pub. No.: US 2006/0135147 A1
(43) Pub. Date: Jun. 22, 2006

(54) Mobile station for retrieving an information related to an association tree

(76) Inventors: Yueheng Li, Shanghai (CN); Ni Ma, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/541,402

(22) PCT Filed: Dec. 10, 2003
(86) PCT No.: PCT/IB03/06286

§ 371 Date: Jul. 1, 2005

(30) Foreign Application Priority Data
Jan. 13, 2003 (EP) 03075075.6

(51) Int. Cl. H04Q 7/20

(52) U.S. Cl. 455/422.1

(57) ABSTRACT

A mobile station for use in a telecommunication system is arranged to receive a signal from a base station. The signal comprises multiple communications, each communication of the multiple communications has first and second characteristics for enabling retrieval of a communication from the received signal. The mobile station is also arranged to receive a reference to said first and second characteristics which is used to obtain the first and said second characteristics.

This invention relates to a mobile station for use in a telecommunication system. The invention further relates to a base station for use in a telecommunication system and to a signal for transmission from a base station to a mobile station. The field of the invention are telecommunication systems such as UTRA-TDD and in particular use of advanced detection algorithms such as Joint Detection or Multi User Detection by mobile stations in such a telecommunication system. In fact, Joint Detection or Multi User Detection are generic names for algorithms such as ZF-BLE (Zero Forcing Block Linear Equalizer), PIC (Parallel Interference Cancellation), SIC (Successive Interference Cancellation).

European patent EP 1 137 201 A1 discloses a method for enabling a mobile station to use advanced detection algorithms, such as Joint Detection, that are normally implemented at the base station-side. To this end, a base station transmits a word representative of transmission parameters respectively allocated to the mobile stations in communication with that base station. It is disclosed that a selection unit is provided to select some midambles in relation with a word W. The word W has as many elements as the number of available midambles m⁽ⁱ⁾ so that one element wᵢ of the word W corresponds univocally to one midamble m⁽ⁱ⁾. The first element corresponds to the first midamble, the second element corresponds to the second midamble and so on. All selected midambles are summed in a summation unit in order to form the general midamble of the Burst N. At a mobile station side, a correlation with a special sequence based on a basic midamble code (BMC) is performed which results in a received word Wᵣ that is a representation of all selected midambles.

It is an object of the present invention to enable a mobile station to efficiently use an advanced detection algorithm. This object is according to the invention realized in that said mobile station is being arranged to receive a signal from a base station, the signal comprising multiple communications, each communication of said multiple communications having a first characteristic and a second characteristic enabling retrieval of said communication from said signal, the mobile station further being arranged to receive a reference to said first and second characteristics and to obtain said first and said second characteristics through said reference. The invention is based on the insight that solely on the basis of available midamble codes advanced detection algorithms cannot be used in a mobile station in an efficient way.

In an embodiment of the present invention said first characteristic comprises a midamble code and said second characteristic comprises a spreading code. Herewith the mobile station does not have to rely on blind spreading code detection whereby the mobile station would have to correlate the received communication signal with all possible spreading codes.

According to another embodiment of the present invention, said reference to said first and second characteristics is a reference to an association tree for defining associations between said first and second characteristics. The relations between the first and second characteristic e.g. the midamble code and the spreading code are relations that are standardized by standardization committees such as 3GPP, the 3^{rd} Generation Partnership Program for defining 3G communication systems. The relations are typically defined in the form of a tree, see e.g. FIG. B.2.1 on page 72 of 3GPP TS 25.221 V4.1.0. By providing information on said association tree, the mobile station does not only know which midamble codes may be used, but it also knows which spreading code or channelization code, can be associated to that midamble code.

According to an embodiment of the present invention said reference to said association tree comprises a maximum number of mobile stations that can be communicating with said base station. The associations laid down in the association tree are used by the base station to code each communication of said multiple communications. There are however multiple association trees, each of which may be used by said base station. The choice for a specific tree depends on the number of midamble codes, i.e. said first characteristics, that are needed within the telecommunication system. Each mobile station is assigned a single and unique midamble code. Therefore, the number of midamble codes matches the number of mobile stations that can be in communication with said base station. For that reason, it is possible to determine the used association tree from the number of mobile stations that can be in communication with said base station.

According to an embodiment of the present invention said reference to said first and second characteristic, comprises a representation of a relation between said first characteristic and said second characteristic. Although in many cases there may be a one-to-one relation between said first and second characteristics it is equally possible that said first characteristic is associated with multiple second characteristics i.e. multiple spreading codes. This is e.g. the case if a mobile station has a need for a higher transmission capacity. If a mobile station would have no additional information on the one-to-many relations between said first characteristic and said second characteristics, it would have to rely on blind code detection for detecting the second characteristics that are being used by said communications. By defining the relation between said first and said second characteristics for possible one-to-many relations only, blind code detection can be avoided whilst at the same only a limited amount of additional information has to be transmitted to the mobile station.

According to another embodiment of the present invention, said reference to said first characteristics comprises the actual number of mobile stations that are communicating with said base station. This parameter may serve as kind of a quality indicator since the number of mobile stations that are in communication with said base station must match the number of first characteristics since each communication of said multiple communications has only a single of said first characteristics assigned.

According to an embodiment of the present invention said reference to said first characteristic comprises a representation of said first characteristic. By providing a representation of the first characteristic, the mobile station can omit the intermediate step of first having to obtain the representation of said first characteristic by correlating the received signal with a basic midamble code. Therefore, this embodiment is more effective and less prone to errors particularly, if the propagating channels are suffering from degrading effects like multipath of flat Raleigh fading.

These and other aspects of the present invention will be elucidated further by means of the following drawings.

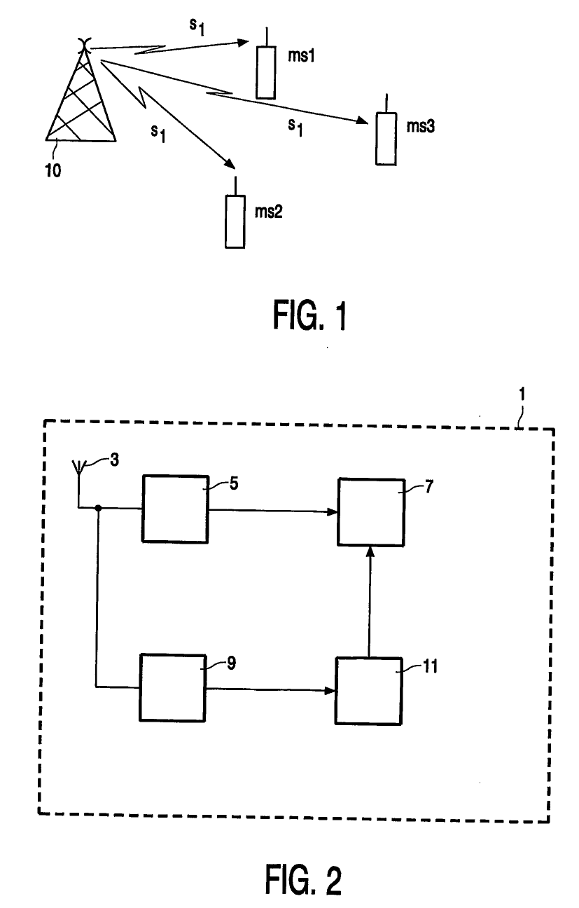

FIG. 1 shows a telecommunication system according to the present invention.

FIG. 2 shows a mobile station according to the present invention.

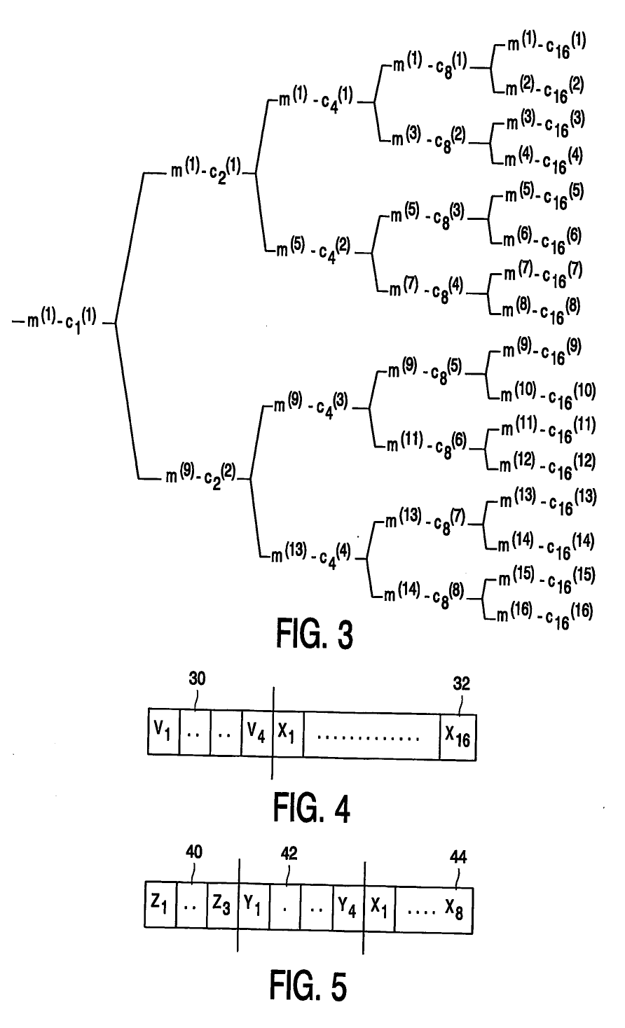

FIG. 3 shows an example of an association tree between midambles and spreading codes according to 3GPP TS 25.221 V4.1.0 (2001-06).

FIG. 4 shows a first embodiment of the coded word according to the present invention.

FIG. 5 shows a second embodiment of the coded word according to the present invention.

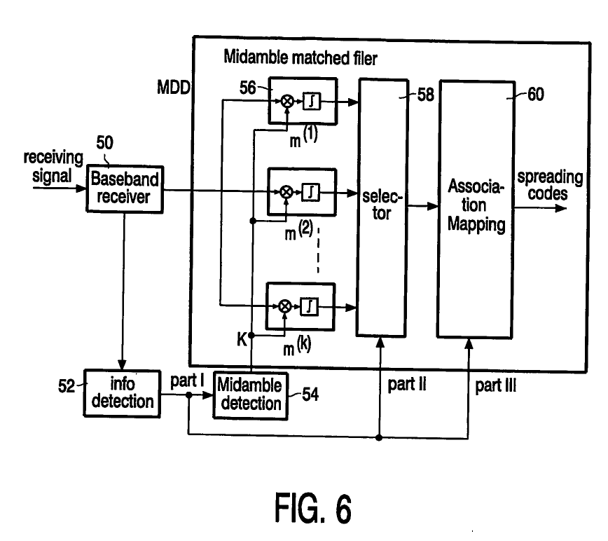

FIG. 6 shows a block diagram of a hybrid method to determine the used midambles and the association between the used spreading codes and the used midambles.

FIG. 1 shows a telecommunication system based on UTRA-TDD. Shown is a base station 10, which is in communication with mobile stations MS1, MS2 and MS3. Each mobile station receives an identical signal S1 that is transmitted by the base station. Although S1 comprises multiple communications intended for each of the mobile stations MS1, MS2 and MS3, a mobile station can only retrieve its own part of the information. For this purpose each mobile station is assigned a personal midamble code and at least one spreading code. In order to improve overall system performance, the mobile stations MS1, MS2 and MS3 might use advanced retrieval algorithm like Multi User Detection or Joint Detection. Typically, these algorithms are used by base station 10. This requires that the base station has to inform the mobile stations MS1, MS2 and MS3 about the active midamble codes and associated spreading codes.

FIG. 2 shows a mobile station 1, having an antenna 3 and means 5 for receipt of signal S1. The received signal S1 is coupled to means 7 for retrieving each communication from the multiple communications by means of an advanced detection algorithm that uses the first and second characteristics of each communication. Means 9 are arranged to receive a reference to the first and second characteristics from which means 11 can determine the first and second characteristics. Subsequently, means 11 provides the first and second characteristics to means 7 so that they can be used by the advanced detection algorithm.

FIG. 3 shows an example of an association tree that defines the relation between the midamble and the spreading code(s). The example is taken from the 3GPP technical specification TS 25.221 version V4.1.0 (2001-06). FIG. 3 is an association tree that can be used in case a maximum number of 14 mobile stations (K=14) can be in communication with the base station. It should be noted that in most cases there is a unique relation between midamble and spreading code. However, if a mobile station requires a higher transmission capacity, it can get a midamble assigned that can be associated with multiple spreading codes. In FIG. 3 for example, midamble m⁽¹³⁾ can be associated with two spreading codes i.e. c₁₆⁽¹⁴⁾, c₁₆⁽¹³⁾ thereby doubling the transmission capacity if required.

FIG. 4 shows a first embodiment of a coded word according to the present invention. The coded word comprises two parts. Part I 30 defines the maximum number of mobile stations (K) that can be in communication with base station 10. By means of example, Part I 30 is four bits wide. The maximum number of mobile stations defines the association tree that is in use by the system. Once the association tree is identified, the relations that exist between midamble and spreading codes are known. Part II 32 defines the active midambles. There are as much active midambles as there are active mobile stations. Xᵢ equals one, indicates that midamble m⁽ⁱ⁾ is existing. As an example the second part is 16 bits wide. The remainder of the 16 bits, that are not used for the definition of the active midambles, are used to define the association between spreading code and midamble code in case this relation is ambiguous. For example, with K=16 (not shown here) there is no ambiguity since in this case, each midamble is associated with a single spreading code. With K=14 however, m⁽¹³⁾ can be assigned to c₁₆⁽¹⁴⁾ or to c₁₆⁽¹⁴⁾ & c₁₆⁽¹³⁾ and m⁽¹⁴⁾ can be assigned to c₁₆⁽¹⁶⁾ or to c₁₆⁽¹⁶⁾ & c₁₆⁽¹⁶⁾. By defining that X₁₅ equals zero means that m⁽¹³⁾ is assigned to c₁₆⁽¹⁴⁾ and X₁₅ equals one means that c₁₆⁽¹⁴⁾ & c₁₆⁽¹³⁾ are being assigned to m⁽¹³⁾, the relation between midamble code and spreading code can unambiguously be defined. Equally, by defining that X₁₆ equals zero means that m⁽¹⁴⁾ is assigned to c₁₆⁽¹⁶⁾ and X₁₆ equals one means that c₁₆⁽¹⁶⁾ & c₁₆⁽¹⁵⁾ are assigned to m⁽¹⁴⁾, the relation between m⁽¹⁴⁾ and the corresponding midambles can also be unambiguously defined. Clearly associations for other K factors (maximum number of mobile stations) can be coded using the same strategy.

FIG. 5 shows a second embodiment according to the present invention. In this case the word comprises of three parts. Part I 40, defines the maximum number of mobile stations that may be in communication with the base station 10. Again this information is required to determine the association tree that is in use by the system. Part II 42 defines the number of mobile stations that is in communication with base station 10. Actually, this number might be less than the maximum number of mobile stations that can be in communication with base station 10. Part III 44 defines the relation between a midamble code and spreading codes in case this relation is ambiguous. For example with K=14 this could mean that if X₁ equals zero, m⁽¹⁴⁾ is assigned to c₁₆⁽¹⁶⁾ and if X₁ equals one, c₁₆⁽¹⁶⁾ & c₁₆⁽¹⁵⁾ are assigned to m⁽¹⁴⁾. Likewise if X₂ equals zero, m⁽¹³⁾ is assigned to c₁₆⁽¹⁴⁾ and if X₁ equals one, c₁₆⁽¹⁴⁾ & c₁₆⁽¹³⁾ are assigned to m⁽¹³⁾. The midambles however, would still have to be detected by correlating the received data with all midambles that are defined in the association tree. Clearly associations for other K factors (maximum number of mobile stations) can be coded using the same strategy.

FIG. 6 shows by means of example a midamble detection device for detecting the midambles and associated spreading codes for a coded word according to the second embodiment of the coded word. The received signal is processed by a baseband receiver 50. A first output of the baseband receiver is coupled to a info detection unit 52, this unit decodes the parts I, II and III of the coded word. Part I, which represents the maximum number of users (K) is coupled to the midamble generator 54 which is designed to generate K midambles. Each of the generated midambles is coupled to a first input of one of the midamble correlators. A second output of the baseband receiver is coupled to each of the midamble correlators 56 as well. The output of each of the correlators 56 is coupled to the selector. It has to be understood that a midamble correlatorᵢ for detecting midamble m⁽ⁱ⁾ should only detect m⁽ⁱ⁾ if this midamble is actually used. However, due to disturbing effects like multipath fading it might be possible that not in all cases the correct number of midambles can be detected. However, by passing information on the actual number of users (Part II) to selection unit 58, the actual midambles can reliably be determined. Mapping the midambles to the spreading codes is done by the association mapping 60. To this end, Part III of the coded word is coupled to an input of the application mapping 60.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Mobile station for use in a telecommunication system, said mobile station being arranged to receive a signal from a base station, the signal comprising multiple communications, each communication of said multiple communications having a first characteristic and a second characteristic enabling retrieval of said communication from said signal, the mobile station further being arranged to receive a reference to said first and second characteristics and to obtain said first and said second characteristics through said reference.

2. Mobile station according to claim 1, wherein said first characteristic comprises a midamble code and said second characteristic comprises a spreading code.

3. Mobile station according to claim 1, wherein said reference to said first and second characteristics is a reference to an association tree for defining associations between said first and second characteristics.

4. Mobile station according to claim 3, wherein said reference to said association tree comprises a maximum number of mobile stations that can be communicating with said base station.

5. Mobile station according to claim 1, wherein said reference to said first and second characteristics comprises a representation of a relation between said first characteristic and said second characteristic.

6. Mobile station according to claim 1, wherein said reference to said first characteristic comprises the actual number of mobile stations that are communicating with said base station.

7. Mobile station according to claim 1, wherein said reference to said first characteristic comprises a representation of said first characteristic.

8. Mobile station according to claim 7, wherein said representation of said first characteristic comprises a binary word, each bit of said binary word indicating whether said first characteristic is used by said multiple communications.

9. Mobile station according to claim 1, wherein said reference to said first and second characteristics is transmitted in a channel.

10. Mobile station according to claim 9, wherein said channel is a broadcasting channel.

11. Mobile station according to claim 1, wherein said communication is retrieved from said multiple communications using a multi user detection algorithm.

12. Mobile station according to claim 1, wherein said communication is retrieved from said multiple communications using a joint detection algorithm.

13. Base station for use in a telecommunication system, said base station being arranged to transmit a-signal to a mobile station, the signal comprising multiple communications, each communication of said multiple communications having a first characteristic and a second characteristic enabling retrieval of said communication from said signal, the base station further being arranged to transmit a reference to said first and second characteristics through which said first and said second characteristic can be obtained.

14. Signal for transmission from a base station to a mobile station, said signal comprising a reference to a first characteristic and a second characteristic, said first and second characteristic enabling said mobile station to retrieve a communication from received multiple communications and said reference enabling said mobile station to retrieve said first and second characteristics.
